(19) United States
(12) Patent Application Publication
(10) Pub. No.: US 2004/0015865 A1
(43) Pub. Date: Jan. 22, 2004

(54) Component/web service data synthesis

(76) Inventors: Kevin Cirone, Nashua, NH (US); Thomas Mayberry, Holliston, MA (US); Peter Savage, Mount Vernon, NH (US); Mark Trumpler, Lexington, MA (US)

Correspondence Address: DALY, CROWLEY & MOFFORD, LLP, SUITE 101, 275 TURNPIKE STREET, CANTON, MA, 02021-2310, US

(21) Appl. No.: 10/098,068

(22) Filed: Mar. 13, 2002

Related U.S. Application Data
(60) Provisional application No. 60/277,072, filed on Mar. 19, 2001.

(51) Int. Cl. G06F 9/44

(52) U.S. Cl. 717/124; 717/131

(57) ABSTRACT

The present invention provides data synthesis for a test sequence used to test methods of a software component. The present invention allows a wide variety of data types and forms to be synthesized in order to test the component. The present method generates parameter data and places it into a data table where each row of the table provides a single instance of that data for the method.

### CROSS REFERENCE TO RELATED APPLICATIONS

This application claims priority under 35 U.S.C. § 119(e) to provisional patent application serial No. 60/277,072, filed Mar. 19, 2001; the disclosure of which is incorporated by reference herein.

### BACKGROUND OF THE INVENTION

Componentized software is software that is designed to allow different pieces of the application, known as “software components” or “objects”, to be created separately but still to have the objects work together. The objects have standard interfaces that are understood and accessed by other objects. The software language enforces some parts of these interfaces. If the interfaces are not used, the software objects will not be able to work with other objects.

An example of a software component is an Enterprise Java Bean™ software component (EJB). EJBs are written in the JAVA language, which is intended to be “platform independent.” Platform independent means that an application is intended to perform the same regardless of the hardware and operating system on which it is operating. Platform independence is achieved through the use of a “container.” A container is software that is designed for a specific platform. It provides a standardized environment that ensures the application written in the platform independent language operates correctly. The container is usually commercially available software and the application developer will buy the container rather than create it.

Typically, applications comprising combinations of software components have been tested in one of two manners. In the first manner, the objects are tested as they are written. Each object is tested to ensure that it performs the intended function. In the second manner, the objects are assembled into a completed application and the entire application is then usually tested. Heretofore, application testing has generally been done by applying test inputs at the client end and observing the response of the application.

Tools are available to automate the execution of tests on applications. For example, Empirix Inc. of Waltham, Mass., provides a product called e-Load™. This tool simulates load on an application under test and provides information about the performance of the application. Another tool known as Bean-test™ also available from Empirix Inc. of Waltham, Mass., tests individual software components.

Automatic test generation tools, such as TestMaster™ available from Empirix Inc. of Waltham, Mass., are also available. Tools of this type provide a means to reduce the manual effort of generating a test. TestMaster™ works from a state model of the application under test. Such an application is very useful for generating functional tests during the development of an application. Once the model of the application is specified, TestMaster™ can be instructed to generate a suite of tests that can be tailored for a particular task—such as to fully exercise some portion of the application that has been changed. Model based testing is particularly useful for functional testing of large applications, but is not fully automatic because it requires the creation of a state model of the application being tested. While all of the above-described tools have proved to be useful for testing software components and applications that include software components, they are not able to test Web Services.

A Web Service is programmable application logic which is accessible using standard Internet protocols such as Hypertext Transfer Protocol (HTTP). Web services represent black-box functionality that can be reused without worrying how the service is implemented. Web services use a standard data format such as Extensible Markup Language (XML). A Web Service interface is defined in terms of the messages the Web Service accepts and produces. Users of the Web Service can be utilizing any platform in any programming language as long as they can create and consume the messages defined for the Web Service interface.

While software components can be tested by commercial software as described above, the testing of Web Services is more difficult. Similar to software components, Web Services provide functionality that can be used multiple times and by multiple different applications running on multiple different systems. Web services are accessed via web protocols such as Hypertext Transfer Protocol (HTTP) and by data formats such as Extensible Markup Language (XML). A Web Service interface is defined in terms of messages the Web Service can accept and generate. Users of the Web Service can be implemented on any platform and in any programming language, as long as they can create and consume the messages defined for the particular Web Service being utilized.

A protocol has been defined for performing information interchange with Web Services. This protocol is the Simple Object Access Protocol (SOAP). Typically objects are platform dependent, thus an object created on one platform cannot be used by software running on other platforms. Some distributed object technologies require the use of specific ports to transmit their data across the Internet (for example, DCOM uses port 135). Most firewalls prevent the use of all ports except for port 80, which is the default port for HTTP communications.

SOAP provides a platform independent way to access and utilize Web Services located on different distributed systems, and allows communications through firewalls. SOAP utilizes XML, and XML documents are transported via HTTP through firewalls.

SOAP messages are sent in a request/response manner. SOAP defines an XML structure to call a Web Service and to pass parameters to the Web Service. SOAP further defines an XML structure to return values that were requested from the Web Service. SOAP further defines an XML structure for returning error values if the Web Service cannot execute the desired function.

A system has an application residing thereon. Part of the application requires use of a particular Web Service which may be located on a remote machine. The application composes a SOAP message and sends the message to the server. The message travels across a network such as the Internet, and is received by the remote server which has the requested Web Service residing thereon. Once the SOAP message has been received by the server, the Web Service is called. Once the Web Service has finished processing (by executing methods of the web service), a SOAP message is prepared to be sent back to the application. The message is sent across the Internet to the system where it is processed by the application. In such a manner the Web Service is utilized by an application on a system remotely located from the Web Service. As described above SOAP allows systems to be highly distributed. Accordingly, developers are able to rely on the expertise and existing proven code of other developers to more quickly build more reliable systems.

For purposes of this description, the term software component will be used to include software components such as EJBs (Enterprise Java Beans™), COM (Component Object Model), COM+, DCOM (Distributed Component Object Model) and CORBA (Common Object Request Broker Architecture) and also web services such as the net web service from Microsoft Corporation. A software component is tested by making sequences of calls to the methods of the component. As these methods are executed, the software component returns results via a return value or output parameter. These resulting values are validated against a set of criteria and any failures are reported to the user. In order to properly test a software component, whether it is for functional testing or for load testing, a test engineer must provide one or more method calls to the software component being tested.

A test plan for performing either a functional or a load test of a component or web service comprises a sequence of method calls to the component under test. These methods will in general need data passed to them via their formal parameters. This passed data will have a variety of requirements. This data may have a variety of data types including primitive types (integer, string,) as well as more complex data types (dates, phone numbers, etc). This data may include strings formatted as XML, which constitutes a complex data type containing multiple data types. This data may include XML wrapped in a SOAP envelope. The data required for these formal parameters might need to be based on the results returned from previously executed methods. The data required for these formal parameters might need to track the values of other parameters in other methods of the sequence. The data for the parameters might need to be different based on which virtual user (during load testing) is executing the test sequence. When parameter data for a method needs to vary, it might need to vary in either a sequential manner or it may need to vary randomly. The data for the parameters may need to come from a fixed set such as from a file or a database.

In view of the foregoing it would be desirable to provide user-defined parameter data synthesis for testing software components. It would be further desirable if the user-defined data can be generated and stored, and each call to a method of the software component would reference the synthesized data corresponding to the particular method.

### SUMMARY OF THE INVENTION

With the foregoing background in mind, it is an object of the present invention to provide data synthesis for a test sequence used to test methods of a software component. The present invention allows a wide variety of data types and forms to be synthesized in order to test the component. The present method generates parameter data and places it into a data table where each row of the table provides a single instance of that data for the method of the software component under test.

### BRIEF DESCRIPTION OF THE DRAWINGS

The invention will be better understood by reference to the following more detailed description and accompanying drawings in which:

FIG. 1 is a flow chart showing the method of the present invention; and

FIG. 2 is a printout of a table generated in accordance with the present invention.

### DETAILED DESCRIPTION

The present invention tightly integrates test sequence generation and execution with parameter data synthesis. During the development of a test plan (sequences of method calls to the component under test), the user is provided with several techniques for producing the data required by each method in order for the methods of the component to be tested. This parameter data is collected into tables where the various rows represent one instance of the data required for a method call. There are multiple aspects of this invention each of which are listed and discussed below.

The data provided as input for the methods of the software component being tested may have different types and different formats. The following data types are supported by the present invention: boolean, byte, integer, string, long integer, single float, double float, currency, date, time, percentile, variant, XML, phone number, zip code, and social security number. Other data types may also be supported. The user has the ability define their own data types and have them synthesized as would any other data type. These user-defined types include strings formatted as specified by the user. For example, if the user wishes to synthesize employee numbers that have the format: 50-XXX-XXXX (where X can be any integer), they will be able to provide a specification for this format and the system will automatically synthesize valid (or invalid if desired) values.

The synthesis methodology generates parameter data and places it into a data table where each row of the table provides a single instance of that data. Each methodology can generate both valid data as well as invalid data. Universally unique values for a parameter may also be generated. The several methodologies are described below.

One of the methodologies utilized to synthesize data is known as a Sequential Method. Given a minimum parameter data value and a maximum parameter data value, this methodology will generate parameter data, in order, from the minimum to the maximum value. Data may also be generated in a reverse order if requested by the user.

Another methodology is known as a Random Methodology. Given a minimum and maximum value, this methodology generates random parameter data falling between the specified minimum and maximum limits.

A Distributed Methodology may also be used. This methodology will generate a value at the minimum and maximum points as well as one value that falls randomly between the minimum and maximum limits.

A further methodology that may be used is a Manual Methodology. In this methodology values for parameters may be explicitly specified as single values or as lists of values.

Another methodology is known as a Reference Methodology. In this methodology the data synthesis mechanism enables a parameter to reference a return value, an input parameter value, or an output parameter value of a previously executed method. That is, a parameter can be instructed to take on the value of another parameter, or take on a value resulting from the component under test.

XML is another methodology supported by the present invention. Components often accept or return data formatted as XML. Synthesizing this XML data is accomplished by providing one of the standard XML schemas (DTD or X-Schema) that define the format of the XML data. From this schema, the XML data is generated as if it were just another data type. This frees the user from the rather complex and time-consuming task of manually generating the data in this format.

Another methodology is known as SOAP (Simple Object Access Protocol) methodology. The SOAP methodology provides an envelope that contains XML. This protocol is widely used by Web Services in a .net environment. The presently disclosed invention will also synthesis the SOAP packets required to test a component.

Still another methodology comprises an Import Methodology. In this methodology parameter data is imported from files of various formats such as a comma-separated-file. Data may also be imported directly from a database using SQL or a similar query language.

One alternative to the data synthesis provided in this invention is to completely separate the data synthesis from the test tool. This would require a manual entry of the data or some import mechanism. The preferred embodiment described here has the advantage in that it tightly integrates the testing with the data, which improves both functionality and ease of use. This invention has been designed such that other synthesis methodologies and data types may be added.

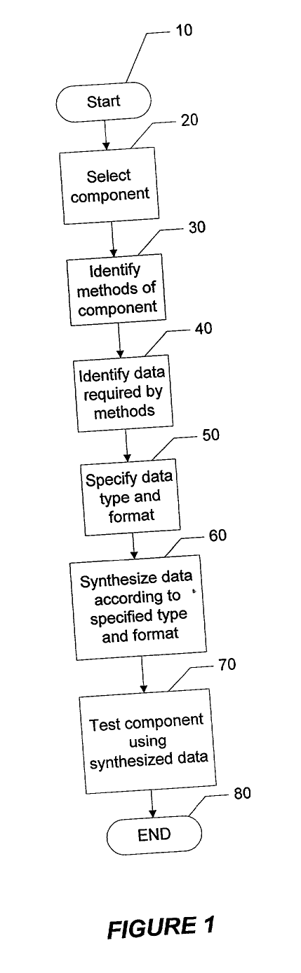

A flow chart of the presently disclosed method is depicted in FIG. 1. The rectangular elements, are herein denoted “processing blocks” and represent computer software instructions or groups of instructions. The diamond shaped elements, are herein denoted “decision blocks,” represent computer software instructions, or groups of instructions which affect the execution of the computer software instructions represented by the processing blocks.

Alternatively, the processing and decision blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

The method is started in step 10. This starting step may include performing such functions as loading the desired software or tool, initializing the system, initializing tables, initializing counters, or the like.

Step 20 is performed next. At step 20 the software component to be tested is selected. As described above any software component may be tested including EJB, COM, DCOM, COM+, CORBA or .net.

The next step, step 30, identifies the methods of the component. A component may include any number of methods. Each of the methods of the component is identified such that any or all of the methods may be called as part of testing the component.

At step 40 the data required by the methods when they are called is identified. Different methods may require different data to be passed to them as part of the method call.

Following the completion of step 40, step 50 is executed. At step 50 the user specifies the data type and format for the different methods. Several different types of data can be specified, as well as different formats for the data.

Step 60 is executed next. At step 60 the data is synthesized according to the data type and format specified by the user. The synthesized data is then stored, typically in a table wherein each row of data includes the data required for a method call. Each method may have its own table of synthesized data.

Step 70 is then executed wherein the component is tested using the synthesized data. The component is tested by performing method calls to the component, and the synthesized data is included as part of the method calls.

Once the component has been tested using the synthesized data, the process is finished as shown at step 80.

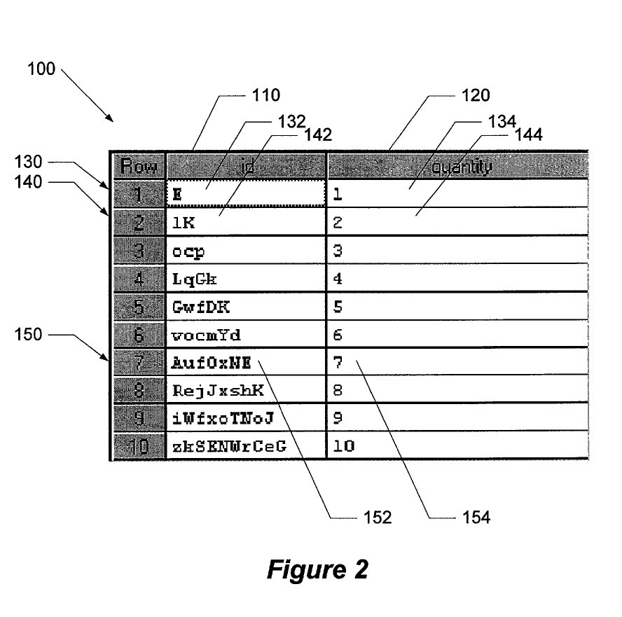

Referring now to FIG. 2, a table 100 of synthesized data provided by the present invention is shown. For this example, the table 100 was produced for providing data for a single method having two parameters passed thereto. The method is part of a shopping cart application, and the method is the AddItem method. The format of the method requires that when the method is called, two parameters will be passed to the method. The parameters will be the identity of the item being purchased and the quantity of the item(s) being purchased.

In order to synthesize data for this method, a table was generated having two columns. The first column 110 contains the identities of the item being purchased. The second column 120 contains the quantity of the associated item to be purchased. The format of the method call is:

AddItem(id,quantity).

The data provided to the table was synthesized by the operator requesting a sequential listing of items for the first column and also a sequential listing of integers to provide the second column of data. This data was synthesized to produce the table 100 of FIG. 2.

In use, the method calls to AddItem will access a row of the table to provide instances of the required parameter data. Accordingly, the first method call to AddItem references the first row 130. The method call will pass the parameters E (box 132) to identify the item and 1 (box 134) to indicate the quantity of the item. The resulting method call will have the format:

AddItem(E,1)

The second method call to AddItem will utilize the next row 140 of the table 100. The second method call will pass the parameters 1K (box 142) to identify this item, and 2 (box 144) to indicate the quantity for this item. The second method call to AddItem will have the format:

AddItem(1K,2)

This is continued for subsequent method calls to the AddItem method. For example, the seventh method call will utilize the synthesized data of the seventh row 150 of table 100. This call will pass the parameters AufOxNe (box 152) and the quantity 7 (box 154). This method call will have the format:

AddItem(AufOxNE,7).

In such a manner the parameters required by method calls can be produced in accordance with user-defined characteristics, such that testing of the component can be performed in an expedient and user-defined manner.

The above-described invention provides data synthesized in accordance with a user-defined format which is then used by a test sequence used to test methods of a software component. The invention allows a wide variety of data types and forms to be synthesized in order to test the component. The method generates parameter data and places it into a data table where each row of the table provides a single instance of that data for the method.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A method for providing data synthesis for a test sequence comprising:
identifying a software component to be tested;
identifying methods of the software component;
synthesizing data for a method of the software component according to user-defined criteria; and
storing said synthesized data.

2. The method of claim 1 wherein said data comprises data having a type selected from the group including boolean, byte, integer, string, long integer, single float, double float, currency, dates, time, percentile, variant, XML, phone number, ZIP code, and social security number.

3. The method of claim 1 wherein said data comprises strings formatted as XML.

4. The method of claim 3 wherein said data comprises XML wrapped in a SOAP envelope.

5. The method of claim 1 wherein said synthesizing is done according to a methodology selected from the group including sequential, random, distributed, manual, reference, XML, SOAP, and import.

6. The method of claim 1 wherein said storing comprises storing said data in a table.

7. The method of claim 1 further comprising testing the component using the synthesized data.

8. The method of claim 6 further comprising testing the component using the table wherein each row of said table represents one instance of data required for a method call.

9. The method of claim 1 wherein said synthesizing data includes synthesizing valid data.

10. The method of claim 1 wherein said synthesizing data includes synthesizing invalid data.

11. A computer program product for providing data synthesis for a test sequence comprising computer usable medium having computer readable code thereon, including program code comprising:
instructions for identifying a software component to be tested;
instructions for identifying methods of the software component;
instructions for synthesizing data for a method of the software component according to user-defined criteria; and
instructions for storing said synthesized data.

12. The computer program product of claim 11 wherein said data comprises data having a type selected from the group including boolean, byte, integer, string, long integer, single float, double float, currency, data time, percentile, variant, XML, phone number, ZIP code, and social security number.

13. The computer program product of claim 11 wherein said data comprises strings formatted as XML.

14. The computer program product of claim 13 wherein said data comprises XML wrapped in a SOAP envelope.

15. The computer program product of claim 11 wherein said synthesizing is done according to a methodology selected from the group including sequential, random, distributed, manual, reference, XML, SOAP, and import.

16. The computer program product of claim 11 wherein said storing comprises storing said data in a table.

17. The computer program product of claim 11 further comprising instructions for testing the component using the synthesized data.

18. The computer program product method of claim 11 further comprising instructions for testing the component using the table wherein each row of said table represents one instance of data required for a method call.

19. The computer program product of claim 11 wherein said synthesizing data includes synthesizing valid data.

20. The computer program product of claim 11 wherein said synthesizing data includes synthesizing invalid data.
